(19) United States
(12) Patent Application Publication
(10) Pub. No.: US 2024/0291368 A1
(43) Pub. Date: Aug. 29, 2024

(54) EDDY CURRENT BRAKE CONFIGURATIONS

(71) Applicant: Eddy Current Limited Partnership, Wellington (NZ)

(72) Inventors: Christopher James Allington, Leeston (NZ); Andrew Karl Diehl, Wellington (NZ); Kevin A. Wright, Wellington (NZ); Weston Hill, Wellington (NZ); Dave Walters, Wellington (NZ)

(21) Appl. No.: 18/659,596

(22) Filed: May 9, 2024

Related U.S. Application Data
(62) Division of application No. 17/393,791, filed on Aug. 4, 2021, now Pat. No. 12,009,721.
Application No. 17/393,791 is a continuation of application No. 15/532,975, filed on Jun. 2, 2017, now Pat. No. 11,114,930.

(30) Foreign Application Priority Data
Dec. 4, 2014 (NZ) 701550

(51) Int. Cl. H02K 49/04; A62B 1/08; A63B 69/00; B60L 7/28; F16D 59/02; F16D 121/20; H02K 7/116; H02K 7/12

(52) U.S. Cl. CPC H02K 49/046; A62B 1/08; B60L 7/28; F16D 59/02; H02K 7/116; H02K 7/12; A63B 69/0048; F16D 2121/20; Y02T 10/64

(57) ABSTRACT

Described herein are eddy current brakes and associated methods of their use, particularly configurations that have a kinematic relationship with at least two rotational degrees of freedom used to tune operation of the brake or apparatus in which the brake is located.

### CROSS-REFERENCE TO RELATED APPLICATIONS

This application is a divisional of U.S. patent application Ser. No. 17/393,791, filed Aug. 4, 2021, which is a continuation application of U.S. patent application Ser. No. 15/532,975, filed Jun. 2, 2017, now U.S. Pat. No. 11,114,930, which is a 371 of International Application No. PCT/NZ2015/050208, filed Dec. 4, 2015, which claims priority to NZ Application No. 701550, filed Dec. 4, 2014, which applications are incorporated herein by reference in their entireties.

### BACKGROUND

### Technical Field

Described herein are eddy current brake configurations and methods of use. More specifically, eddy current brake configurations are described that utilize varying kinematic relationships between the parts.

### DESCRIPTION OF THE RELATED ART

The applicant's co-pending and granted patents in the field of eddy current related devices include U.S. Pat. Nos. 8,851,235, 8,490,751, NZ619034, NZ627617, NZ627619, NZ627633, NZ627630 and other equivalents all incorporated herein by reference.

Eddy current brake configurations work on the principle that an electrically conductive element moving relative to a magnetic field induces eddy current forces that act to resist relative movement between the magnetic field and electrical conductor—i.e. they are retarding forces.

Eddy current brake configurations can be grouped into categories by considering the number of degrees of freedom (DOF) employed by the brake and whether these are linear (L) or rotational (R) degrees of freedom. A 1 DOF rotational configuration may thus be labelled ‘1R’, a 2 DOF linear configuration may be labelled ‘2L’.

A 1L, single linear DOF configuration may take the form of a linear brake configuration that can be realized with an electrical conductor passing an array of magnets (1L) as shown in FIG. 1. An alternative 1L arrangement may be an array of magnets passing an electrical conductor like that used in art roller coaster brakes. A 1R: single rotational DOF can be realized with a plain disc brake such as that shown in FIG. 2.

A 1R1L: one linear and one rotational DOF may be realized for example using the plunger brake described in the applicant's co-pending patent application NZ619034 that has one linear DOF along the brake axis and one rotational DOF about the brake axis. This 1R1L DOF provides the possibility for torque regulation by varying the axial displacement of the electrical conductor with respect to the magnetic array whilst maintaining a continuous electrical conductor.

A further example is the 2R DOF brake described in the applicant's co-pending patent published as U.S. Pat. Nos. 8,851,235 and 8,490,751. The disc brake configuration with integrated kinematic control described in these patents can be categorized as a 2R brake as the kinematic motion of the arms occurs around an axis radially translated or offset from the primary brake axis. The variable overlap of the arms (electrical conductor) with the flux from the magnetic array results in a variable torque brake. The interaction between the centripetal forces, eddy current drag forces and spring bias forces can be configured to give controlled speed regulation independent of input torque.

The devices described in the art may be useful, for example due to their providing frictionless methods of controlling movement. However, other methods of altering eddy current interactions may also be achieved using different configurations or at least provide the public with a choice.

Further aspects and advantages of the eddy current brake configurations and methods of use should become apparent from the ensuing description that is given by way of example only.

### BRIEF SUMMARY

Described herein are eddy current brake configurations and methods of use, particularly configurations that have a kinematic relationship with at least two rotational degrees of freedom used to tune activation and operation of the brake or apparatus in which the brake is located.

In a first aspect, there is provided an eddy current brake configuration comprising:
(a) a magnetic field; and
(b) an electrical conductor;
wherein the magnetic field and electrical conductor move relative to each other and interact thereby inducing eddy current drag forces; and
   wherein the eddy current brake is configured to have at least two rotational degrees of freedom, where a first primary axis of rotation is angularly translated relative to at least one secondary or control axis of rotation and wherein the braking action is applied to the primary axis and the at least one secondary axis is used to modulate of the braking action.

In a second aspect, there is provided a method of generating an eddy current drag force by the steps of:
(a) selecting an eddy current brake configuration substantially as described above;
(b) applying a driving force to cause varying relative movement between the magnetic field and the at least one electrical conductor; and
(c) by causing movement, making the at least one electrical conductor and the magnetic field interact thereby inducing eddy current drag forces and acting to resist relative motion between the magnetic field and the at least one electrical conductor.

Advantages of the above described eddy current brake configuration and method of use include the ability to tune a brake response to a degree that may be difficult to achieve via single degree of freedom configurations. Greater tuning allows for example the ability to brake a great range of torque forces and allows the ability to prevent on/off braking—braking can be of a controlled and/or near constant rate for a range of different input conditions.

### BRIEF DESCRIPTION OF THE SEVERAL VIEWS OF THE DRAWINGS

Further aspects of the eddy current brake configuration and methods of use will become apparent from the following description that is given by way of example only and with reference to the accompanying drawings in which:

FIG. 1 illustrates a prior art single linear degree of freedom eddy current brake configuration;

FIG. 2 illustrates a prior art single rotational degree of freedom eddy current brake configuration;

FIG. 3 illustrates an embodiment of a double rotational degree of freedom eddy current brake configuration with the rotation axes being angularly translated to each other, either intersecting, or not;

FIG. 4 illustrates an alternative embodiment of a double rotational degree of freedom eddy current brake configuration with the rotation axes being angularly translated to each other, either intersecting, or not; and

FIG. 5 illustrates a further alternative double rotational degree of freedom eddy current brake configuration with the rotation axes being angularly translated to each other, either intersecting, or not.

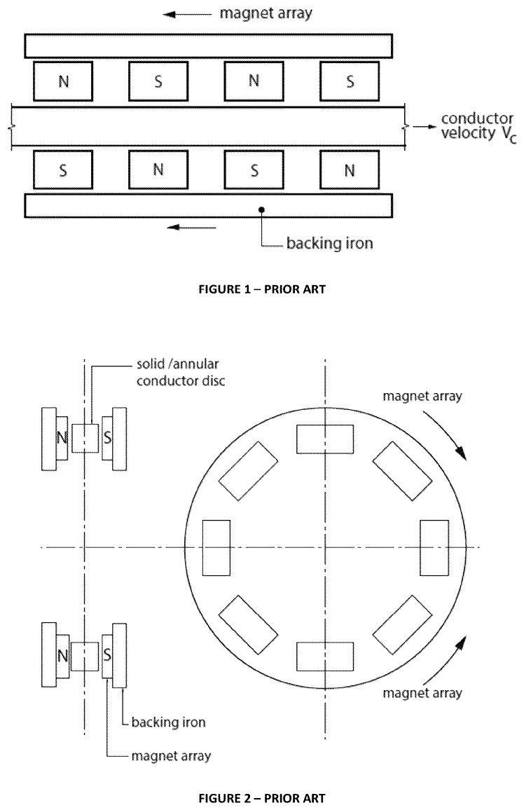

### DETAILED DESCRIPTION

As noted above, described herein are eddy current brake configurations and methods of use, particularly configurations that have a kinematic relationship with at least two rotational degrees of freedom (2R DOF) used to tune operation of the brake or apparatus in which the brake is located.

For the purposes of this specification, the term ‘about’ or ‘approximately’ and grammatical variations thereof mean a quantity, level, degree, value, number, frequency, percentage, dimension, size, amount, weight or length that varies by as much as 30, 25, 20, 15, 10, 9, 8, 7, 6, 5, 4, 3, 2, or 1% to a reference quantity, level, degree, value, number, frequency, percentage, dimension, size, amount, weight or length.

The term ‘substantially’ or grammatical variations thereof refers to at least about 50%, for example 75%, 85%, 95% or 98%.

The term ‘comprise’ and grammatical variations thereof shall have an inclusive meaning—i.e. that it will be taken to mean an inclusion of not only the listed components it directly references, but also other non-specified components or elements.

The term ‘link’ and grammatical variations thereof refer to both direct linkage as well as indirect linkage such as via another member.

In a first aspect, there is provided an eddy current brake configuration comprising:
(a) a magnetic field; and
(b) an electrical conductor;
wherein the magnetic field and electrical conductor move relative to each other and interact thereby inducing eddy current drag forces; and
   wherein the eddy current brake is configured to have at least two rotational degrees of freedom, where a first primary axis of rotation is angularly translated relative to at least one secondary or control axis of rotation and wherein the braking action is applied to the primary axis and the at least one secondary axis is used to modulate of the braking action.

The inventors have identified that a 2R DOF configuration may be useful to tune an eddy current brake configuration. 2R DOF may offer more range and opportunity to vary the brake dynamics than for example a 1R or 1L configuration. The second degree of freedom noted above may introduce kinematic control regulation to the brake, this being a key improvement over the art. Kinematic control may for example allow a controlled output braking response irrespective of input motive force on the braking mechanism. A further advantage is avoidance of hysteresis like on/off switching of a brake response avoiding fluctuations in braking undesirable in many applications where a smooth brake effect is desirable or even essential. Other advantages are described further below.

For the discussion below, one arrangement of electrical conductor(s) and magnets or magnetic field will be described. This arrangement should not be seen as limiting as it should be appreciated that the electrical conductor(s) and magnet(s)/magnetic field may be swapped and still achieve the same result of eddy current brake force generation.

Further, for the discussion below, reference may be made to a single electrical conductor or single magnetic field however, this should not be seen as limiting since multiple electrical conductors or multiple magnetic fields may be used.

The eddy current brake may be configured to have a central point of rotation or pivot. In one embodiment, the central point of rotation may be a first rotating shaft and an electrical conductor may be linked to, and rotate with, the shaft. A shaft may not be essential as the electrical conductor may be supported on the outside of a casing and therefore need no central support. The electrical conductor may be located at least partially within a magnetic field when braking is to occur. Relative movement between the electrical conductor and the magnetic field then induces eddy current braking forces acting to resist movement of the electrical conductor and in turn acts to resist movement of the shaft. The term ‘shaft’ is used in a wide sense-shafts may be cylindrical volumes but may instead be tubes, square, oblong or other shaped elements.

As noted above, the second axis of rotation is in a different plane to that of the first axis of rotation. In one embodiment, the second axis of rotation may be at an angle generally orthogonal to the first degree of freedom axis of rotation although non-orthogonal angles may also be possible. An orthogonal second axis of rotation may assist with system stability and avoid oscillating forces.

The first axis of rotation and at least one second axis of rotation may intersect. For ease of description, reference may be made to the axes intersecting in this specification however this should not be seen as limiting as non-intersecting axes but with angular translation may also be achieved.

In one specific embodiment, the shaft may have a collar, and either one section of the collar, multiple sections of the collar or the whole collar may be an electrical conductor.

The collar may rotate about a second rotation axis mounted on or about the shaft itself. In this embodiment, collar rotation also rotates the electrical conductor. The shaft on which a collar and electrical conductor is mounted may itself be flexible or instead may incorporate a flexible coupling to allow secondary axis rotation of the collar and electrical conductor thereon.

Alternatively, the electrical conductor may rotate about an axis or axes mounted on the collar and, when shaft or a first rotation occurs; at least part of the conductive member(s) rotate outward from the plane of rotation of the collar about a second rotation axis or axes. In this embodiment, the collar may include discrete sections with their own axis of rotation mounted about the collar circumference.

The secondary axis of rotation may be fixed. Alternatively, the secondary axis of rotation may move as prescribed by the kinematic relationship. In addition, the secondary axis of rotation may be an axis that is not physically generated by a pin or shaft, but may rather be an axis of effective rotation resulting from the geometry and kinematics of a movement and restraint mechanism. Non-limiting examples of ways this configuration might be achieved may include by using: a slider in a curved groove, a ‘4 bar linkage’, a flexible leaf spring, and combinations thereof.

The magnetic field within which the electrical conductor moves may be formed by one or more magnets situated on a housing or external element. The housing or external element may define a cavity inside which the shaft and electrical conductor move.

In an alternative embodiment, the electrical conductor may be linked to the shaft via a line (flexible or rigid) and centrifugal forces acting on the electrical conductor member(s) caused by rotation of the shaft urging the electrical conductor to axially rotate away from the shaft. In this embodiment a bias means may be used to tune the axial rate of movement of the electrical conductor away from the shaft axis. In one embodiment, the bias may be a spring.

In a further embodiment, the eddy current brake may be configured to have a shaft that rotates about a first axis of rotation and a collar coupled to the shaft that rotates about the shaft axis of rotation. The collar may comprise a rebate or rebates about the collar circumference with magnets inside the rebate defining at least one magnetic field between the magnets, the magnetic field or fields moving about the shaft axis of rotation. One or more electrical conductors may move rotationally into or out of the magnetic fields about a second axis of rotation mounted on the collar circumference.

In the above aspect, one embodiment may take the configuration of an epicyclic gearbox with a 2R DOF configuration. The gearbox may comprise a sun (e.g., a shaft) with planets (gears, balls, disc etc.) rotating about the sun and with rotation governed by a kinematic and rotationally coupled relationship, the parts maintained in alignment via an annulus. The electrical conductor in this embodiment may be the planets or an attachment thereof that rotate through a magnetic field generated by a magnet array located on either side of the planets so that the magnetic field passes orthogonally across the planets. The first axis of rotation may be rotation of either the sun (shaft) or rotation of the annulus. The second axis or axes of rotation may be rotation of the planets. As movement occurs, there may be a retarding torque induced by movement of the planets around the sun axis and additionally retarding torque induced by the planets rotating about their own secondary rotation axis. The sun may drive the planets via a gear arrangement, by a traction drive, via belts, via friction between the sun and planets and other driving configurations. A bearing can also be thought of as an epicyclic gearbox. In this case, a housing acts as an overall carrier, the balls or rollers of the bearing act as the planets, an outer ring acts as the annulus and an inner ring acts as the sun. An eddy current brake can be configured to act on the inner ring (1R) and/or on the planets (2R).

In a second aspect, there is provided a method of generating an eddy current drag force by the steps of:
(a) selecting an eddy current brake configuration substantially as described above;
(b) applying a driving force to cause varying relative movement between the magnetic field and the at least one electrical conductor; and
(c) by causing movement, making the at least one electrical conductor and magnetic field interact thereby inducing eddy current drag forces and acting to resist relative motion between the magnetic field and the at least one electrical conductor.

In one embodiment, an autobelay or self-retracting lifeline (SRL) embodiment may use the eddy current braking configurations described above. The shaft or first rotating element may have a spool of line thereon and when pay out of line occurs (for example from an object falling); the shaft rotates imparting secondary rotation movement on the electrical conductor. Electrical conductor movement results in eddy current drag forces occurring that act to slow movement of the electrical conductor thus slowing movement of the shaft or first rotating element. Slowing the shaft then slows pay out of the line thereby braking the fall of the object. This example should not be seen as limiting since the eddy current brake configurations described herein may be used for a wide variety of other applications, non-limiting examples including speed control of:
a rotor in a rotary turbine;
exercise equipment e.g. rowing machines, epicyclic trainers;
roller-coasters and other amusement rides;
Elevator and escalator systems;
evacuation descenders and fire escape devices;
conveyer systems:
rotary drives in factory production facilities;
materials handling devices such as conveyer belts or a braking device in a chute;
dynamic display signage to control the rate of change of rotating signs;
roadside safety systems e.g. the eddy current brake may be connected in a system to provide crash attenuation though the dissipation of energy via the brake;
seat belts in vehicles;
zip lines;
braking mechanisms for trolleys and carriages.

Advantages of the above described eddy current brake configuration and methods of use include the ability to tune a brake response to a degree that may be difficult to achieve via single degree of freedom configurations. Greater tuning allows for example the ability to brake a greater range of torque forces and allows the ability to prevent on/off braking—braking can be of a controlled and/or near constant rate for a range of different input conditions.

The embodiments described above may also be said broadly to consist in the parts, elements and features referred to or indicated in the specification of the application, individually or collectively, and any or all combinations of any two or more said parts, elements or features.

Further, where specific integers are mentioned herein which have known equivalents in the art to which the embodiments relate, such known equivalents are deemed to be incorporated herein as of individually set forth.

### WORKING EXAMPLES

The above described eddy current brake configuration and methods of use are now described by reference to specific examples.

### Example 1

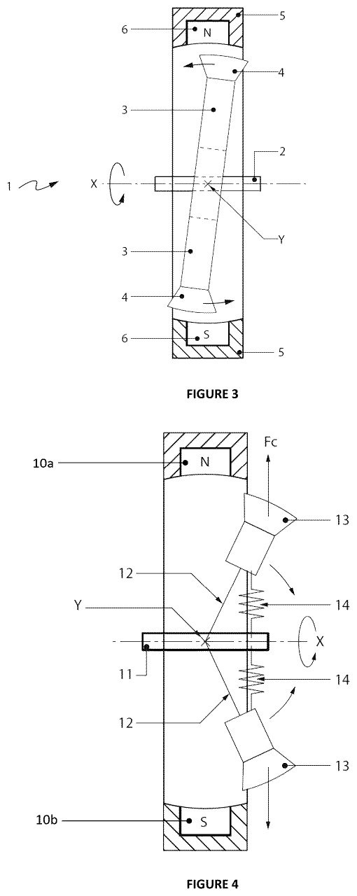

FIG. 3 illustrates how an art 1R eddy current brake configuration may be modified to have a 2R configuration.

The eddy current brake shown generally by arrow 1 has a shaft 2 rotating about axis X. The shaft includes a collar 3 that is linked to the shaft 2. Electrical conductor members 4 are located at either end of the collar 3. The collar 3 is free to rotate about a second axis marked by arrow Y located on or about the center of the collar 3.

During eddy current braking, the shaft 2 and collar 3 are located within a magnetic field formed by a housing 5 about the shaft 2 and collar 3, the housing 5 including magnets 6 that generate the magnetic field.

The electrical conductor members 4 are able to rotationally translate via the second axis of rotation Y into or out of the magnetic field. FIG. 3 demonstrates the electrical conductor members 4 partially outside the magnetic field generated by the magnets 6.

Relative movement between the electrical conductor members 4 (from both first and second degrees of rotation) and the magnetic field then induce eddy current braking forces resisting movement of the electrical conductor members 4 and in turn resisting movement of the shaft 2.

As can be seen in FIG. 3, the second axis of rotation Y is at an angle generally orthogonal to the first axis of rotation X.

The shaft 2 may itself be flexible to allow second axis rotation Y, or instead, the shaft 2 may incorporate a flexible coupling (not shown) to allow second axis rotation Y of the collar 3 and electrical conductor members 4.

Note that additional force modifying and generating means may also be used such as springs although, for clarity, these additional means are not shown.

### Example 2

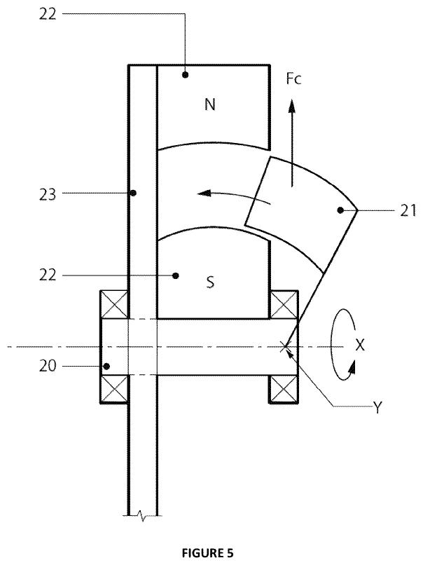

FIG. 4 illustrates an alternative way to achieve a second rotation axis Y for the electrical conductors to rotate about in a 2R configuration. In this embodiment the shaft 11 rotates about first rotation axis X within a magnetic field generated by magnets 10a, 10b located on a housing 10. The electrical conductor members 13 are linked to the shaft 11 via links 12 and a spring 14. The attachment point of the link 12 to the shaft 11 defines a second rotation axis Y. When no first axis X rotation occurs, the electrical conductor members 13 are biased by the spring 14 to a point outside the magnetic field. When first axis X rotation occurs, the electrical conductor members 13 are urged by centrifugal forces to rotate via second axis Y against the bias of the spring 14, into the magnetic field thereby inducing an eddy current brake forces.

Again, note that additional force modifying and generating means may be also be used such as springs although, for clarity, these additional means are not shown.

### Example 3

FIG. 5 demonstrates a further embodiment, this time achieving a segmented or petal 2R configuration.

In this embodiment, the shaft 20 rotates about a first rotation axis X and an electrical conductor member 21 rotates about a second rotation axis Y. In this embodiment, magnets 22 are located on a collar 23 located about the shaft 20. When rotation of the shaft 20 occurs about the first rotation axis X, centrifugal forces urge the electrical conductor member 21 to rotate about second rotation axis Y. Second axis Y rotation causes the electrical conductor member 21 to enter the magnetic field and thereby inducing an eddy current brake force.

As per Example 1 and 2, note that additional force modifying and generating means may be also be used such as springs although, for clarity, these additional means are not shown.

Aspects of the eddy current brake configurations and methods of use have been described by way of example only and it should be appreciated that modifications and additions may be made thereto without departing from the scope of the claims herein.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An eddy current brake, comprising:
a shaft with a first rotation axis;
an electrical conductor member linked via an attachment point to the shaft, the electrical conductor member extending from the first rotation axis of the shaft and the electrical conductor member rotating with the shaft about the first rotation axis of the shaft when the shaft rotates about the first rotation axis of the shaft; and
a collar configured to generate a magnetic field, the collar either stationary or moving independent to the shaft when the shaft rotates;
wherein, when relative movement between the electrical conductor member and magnetic field occurs and the electrical conductor member interacts with the magnetic field, eddy current drag forces are induced slowing relative movement between the electrical conductor member and magnetic field; and
wherein the attachment point of the electrical conductor member to the shaft defines a second rotation axis and, when no rotation of the shaft about the first rotation axis occurs, the electrical conductor member lies at least partially outside the magnetic field and, when rotation of the shaft about the first rotation axis occurs, the electrical conductor member is urged by centrifugal forces to rotate via the second rotation axis, into the magnetic field thereby causing an eddy current brake force to be induced.

2. The eddy current brake as claimed in claim 1, wherein the electrical conductor member is biased via a spring to move the electrical conductor member outside the magnetic field.

3. The eddy current brake as claimed in claim 1, wherein the electrical conductor members is located at least partially within the magnetic field when the shaft is not rotating about the first rotation axis.

4. The eddy current brake as claimed in claim 1, wherein the electrical conductor member is located outside the magnetic field when the shaft is not rotating about the first rotation axis.

5. The eddy current brake as claimed in claim 1, wherein the eddy current brake comprises multiple electrical conductor members.

6. The eddy current brake as claimed in claim 1, wherein the second rotation axis is not parallel to the first rotation axis.

7. The eddy current brake as claimed in claim 1, wherein the first rotation axis is orthogonal to the second rotation axis.

8. The eddy current brake as claimed in claim 1, wherein the electrical conductor member is biased by a spring to rotate about the second rotation axis away from a plane of rotation of the electrical conductor member about the first rotation axis.

9. The eddy current brake as claimed in claim 1, wherein the first rotation axis and the second rotation axis intersect.

10. An autobelay device incorporating the eddy current brake as claimed in claim 1.

11. A self-retracting lifeline (SRL) device incorporating the eddy current brake as claimed in claim 1.

12. An eddy current brake, comprising:
a shaft with a first rotation axis;
a collar linked to the shaft about a mid-point of the collar, the collar extending orthogonally from either side of the first rotation axis and the collar rotating with the shaft about the first rotation axis when the shaft rotates about the first rotation axis;
wherein the collar comprises at least one electrical conductor at one or both ends of the collar that interacts with an adjacent magnetic field and, when relative movement between the at least one electrical conductor and magnetic field occurs, eddy current drag forces are induced slowing relative movement between the at least one electrical conductor and magnetic field; and
wherein the collar also rotates about a second rotation axis, the second rotation axis being aligned in a direction orthogonal to the first rotation axis, and wherein rotation of the collar about the second rotation axis modulates the eddy current drag forces induced by moving the at least one electrical conductor partly or fully out of or into the magnetic field.

13. The eddy current brake as claimed in claim 12, wherein the at least one electrical conductor is biased via a spring to move outside the magnetic field.

14. The eddy current brake as claimed in claim 12, wherein the electrical conductor member(s) are located at least partially within the magnetic field when the shaft is not rotating about the first rotation axis.

15. The eddy current brake as claimed in claim 12, wherein the electrical conductor member(s) are located outside the magnetic field when the shaft is not rotating about the first rotation axis.

16. The eddy current brake as claimed in claim 12, wherein the eddy current brake comprises multiple electrical conductors.

17. The eddy current brake as claimed in claim 12, wherein the first rotation axis and the second rotation axis intersect.

18. An autobelay device incorporating the eddy current brake as claimed in claim 12.

19. A self-retracting lifeline (SRL) device incorporating the eddy current brake as claimed in claim 12.

20. The eddy current brake as claimed in claim 12, wherein rotation of the shaft causes centrifugal forces to act on the at least one electrical conductor, the centrifugal forces urging the at least one electrical conductor to rotate via the second rotation axis into the magnetic field.
